(19) United States
(12) Patent Application Publication
(10) Pub. No.: US 2017/0017906 A1
(43) Pub. Date: Jan. 19, 2017

(54) TRAVEL BOOKING OPTIMIZATION THROUGH PREFERENCE UTILIZATION

(71) Applicant: ZAG HOLDINGS INC., Toronto (CA)

(72) Inventors: Igal ROYTBLAT, Toronto (CA); Jonathan HALDANE, Toronto (CA)

(21) Appl. No.: 15/125,630

(22) PCT Filed: Mar. 12, 2015
(86) PCT No.: PCT/CA2015/050185

§ 371 Date: Sep. 13, 2016

Related U.S. Application Data
(60) Provisional application No. 61/952,599, filed on Mar. 13, 2014.

(51) Int. Cl. G06Q 10/02; G06Q 30/02

(52) U.S. Cl. CPC G06Q 10/02; G06Q 30/0207; G06Q 50/14

(57) ABSTRACT

Embodiments of the present technology relate to travel booking optimization using preferences. A method includes receiving corporate hotel booking preferences that define hotels or hotel groups that offer discount rates for a corporation, receiving hotel selection criteria from a user, applying the corporate hotel booking preferences to hotels that correspond to the hotel selection criteria, and displaying to a travel agent system hotels that correspond to the hotel selection criteria such that hotels that are included in the corporate hotel booking preferences are displayed differently from hotels that are not included in the corporate hotel booking preferences.

### CROSS REFERENCE TO RELATED APPLICATIONS

This application claims the priority benefit of U.S. Provisional Application Ser. No. 61/952,599, filed on Mar. 13, 2014, which is hereby incorporated by reference herein in its entirety, including all references cited therein.

### FIELD OF THE PRESENT TECHNOLOGY

The present technology relates generally to travel booking, and more specifically, but not by limitation, to systems and methods that utilize various preferences related to corporate, travel agency, or other preference rules in order to encourage the booking of travel inventory, such as hotels so as to maximize available reimbursements to one or more parties involved in the travel booking process.

### SUMMARY

Embodiments of the present technology include a method, comprising: (a) receiving corporate hotel booking preferences that define hotels or hotel groups that offer discount rates for a corporation; (b) receiving hotel selection criteria from a user; (c) applying the corporate hotel booking preferences to hotel inventory that correspond to the hotel selection criteria; and (d) displaying to a travel agent system hotel inventory that correspond to the hotel selection criteria such that hotel inventory that are included in the corporate hotel booking preferences are displayed differently from hotel inventory that are not included in the corporate hotel booking preferences.

Other embodiments of the present technology include a method, comprising: (a) receiving hotel selection criteria relating to a traveler; (b) applying the corporate hotel booking preferences to hotels that correspond to the hotel selection criteria, the corporate hotel booking preferences define hotels or hotel groups that offer discount rates for a corporation; (c) applying travel agency preferences to the hotels, the travel agency preferences comprise hotels or groups of hotels that offer reimbursements to the travel agency; and (d) generating, for a travel agent system, a ranked list of hotels, wherein hotels that are included in the corporate hotel booking preferences and the travel agency preferences are placed near a top of the list.

Additional embodiments of the present technology include a system, comprising: (a) a processor; and (b) a memory for storing executable instructions, the processor executing the instructions to: (i) receive hotel booking preferences that define hotels or hotel groups that offer discount rates or incentives for at least one of a corporation, a travel agency, and a traveler; (ii) receive hotel selection criteria from a user; (iii) apply the hotel booking preferences to hotels received from a hotel database; and (iv) provide to a travel agent system, hotels that corresponds to the hotel selection criteria and the hotel booking preferences.

According to some embodiments, the present technology includes a method for integrating a map-based shopping and booking system with a global distribution system or other system, the method comprising: (a) accepting agency-preferred information; (b) storing the agency-preferred information; (c) allowing edits to be made to the agency-preferred information; (d) for each agency, client and traveler: (i) accepting preference information; (ii) storing preference information; and (iii) allowing edits to be made to the preference information; (e) combining and mixing agency-preferred information, client-preferred information and traveler-preference information; (f) displaying the agency-preferred information, client-preferred information, and traveler-preferred information simultaneously, allowing for comparisons between the agency-preferred information, client-preferred information, and traveler-preferred information to be made, with the display in the form of a map overlay and/or a list display; and (g) allowing for the booking of the selected option from at least one of the agency-preferred information, client-preferred information, and traveler-preferred information to the global distribution system or other system.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a high level schematic diagram of computing architecture for practicing aspects of the present technology.

FIG. 2 is an example screenshot of a graphical user interface for displaying inventory items ranked according to preferences.

FIG. 3 is a flowchart of a method for providing hotel options in accordance with hotel preferences.

FIG. 4 is a flowchart of another method for providing hotel options in accordance with hotel preferences.

FIG. 5 is a schematic diagram of a computing machine that is used to implement embodiments according to the present technology

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

For context, travel agents, agencies, travel management companies (“TMC”s) and global agencies purchase a very large number of hotel rooms every year; hence these buyers have the power to negotiate better rates for their clients as well as incentives for their agencies.

As there are hundreds of hotels chains and loyalty groups, there are a large number of negotiated rates. The agency will organize these hotels chains and loyalty groups into a hierarchy with multiple levels to help guide the agent to book the hotel preferred by the agency.

At the same time, travel agencies that serve corporate clients need to deal with rates that are negotiated directly by the client. For example, larger companies have tremendous negotiating power and receive preferable rates with its hotel partners. When larger companies engage a corporate travel company to manage its travel, it mandates that the TMC will use the negotiated rates for all their corporate bookings. If an agent books a rate that is not preferred by the client, they may be required to attach a special reason code that explains why the booking was not according to contract.

In addition to the general agreements between companies and hotels suppliers there are local agreements with specific hotels. For example, ACME Co. will negotiate a preferred rate for its employees and visitors with a nearby Marriott. Thus, ACME's may be able to drive significant business to a specific local hotel, but may not have enough global presence to negotiate a similar rate with the entire Marriott chain. Therefore in many cases, local preferred hotel rates may trump the preferred rate available from the hotel chain agreement.

In yet another preference layer, the traveler may have different criteria for the selection of the hotel. This may include staying at a property conveniently located to their destination, or a property with a set of specific amenities.

This collection of negotiated rates for each corporate client that the agency serves combined with the agency's own arrangements with hotel suppliers and a desire for the traveler to stay at specific properties creates a complicated decision matrix, requiring travel agents to comply with a large collection of restrictions and limitations. Moreover, since an agent may serve multiple corporate clients, a situation is created whereby there are literally hundreds and thousands of rules to comply with for every booking.

The Global Distribution Systems, such as such as Sabre®, Travelport®, or Amadeus® that drive agency bookings do support rate code management within their systems, but they do not provide shopping tools that facilitate the agent's task to find the best match for the traveler and the agency preferred properties.

Thus, the present technology provides a travel preference management system that allows entering, storing, and editing of agency preferred information such as preferred hotel chains and preferred hotels, and at the same time, also allows entering, storing and editing of corporate client information with their preferred rate codes, preferred chains and preferred hotels. The system can also accommodate global preferences, local agreement preferences, and/or traveler preferences.

Thus, when an agent is serving a particular corporate traveler, the agent can have a clear understanding of the traveling customer's needs and combine that with the preferred options from both the agency's and the corporate client's predetermined arrangements, in some embodiments. The agent can then determine the best property (properties) that matches the competing needs of the corporate client, the travel agency, and, in some instances, the traveler.

In some embodiments, the present technology employs an online administration service and a map based interface to graphically provide options to the agent on ways to meet the needs of the client, agency and traveler. In some embodiments, recommendations of preferred hotels can be provided in a pop up GUI that appears on a travel agent CDS client screen. Other similar GUI displays can be utilized in accordance with the present technology.

In some embodiments an agency administrator can enter the specific data related to agency and client-preferred options. When a traveler requests hotel booking options, the system can query available options and rank the options for the benefit of the travel agent.

In one embodiment, ranked options are color-coded and displayed both on a map and on a list view in a manner where the travel agent can select the inventory that best matches the needs of any of the travel agency, the corporate client, and the traveler. The ranking and unique display of preferred options encourages the travel agent to select a preference-based option over other options that may not correspond to the applied preferences. Again, with the innumerable possible permutations of corporate client, travel agency, global, local, and traveler preferences that could accompany any inventory query, a travel agent is simply unable to determine which options are preferred in a manner that would allow for efficient option selection.

Options can refer to hotels, cars, restaurants, or any other similar item that a travel agent or traveler may book.

In some embodiments, the travel agent can interview the traveler to get their specific hotel needs, including but not limited to price, location and amenities. This information is combined with the preference logic of the travel agency and corporate client to determine the correct hotel to book for the traveler.

Also, while some embodiments describe the querying and display of preference-based options for a travel agent, the present technology can also be implemented at the corporate or individual traveler level.

These and other advantages of the present technology are provided below with reference to the collective drawings.

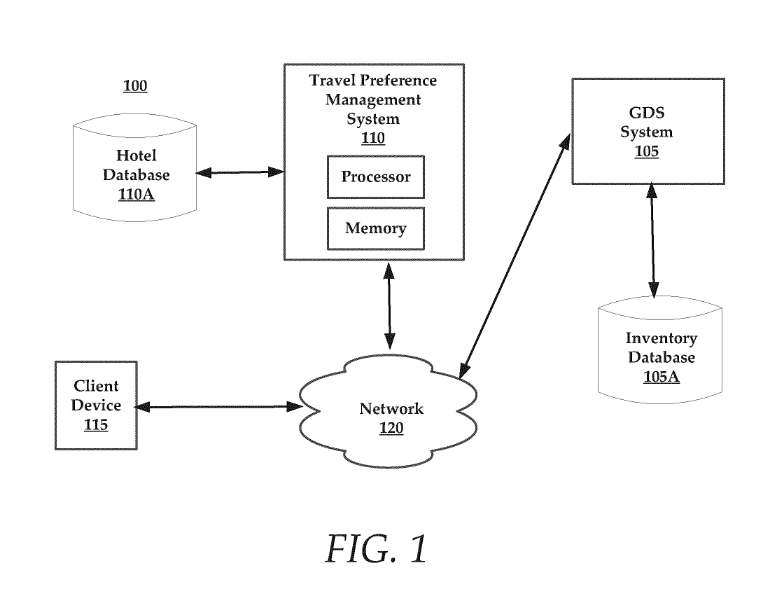

FIG. 1 is a high level schematic diagram of a computing architecture (hereinafter architecture 100) of the present technology. The architecture 100 comprises a global distribution system (GDS) 105, a travel preference management system (hereinafter “system 110”), and a client device 115. These components can be communicatively coupled over any one or combination of public or private networks, such as network 120.

The GDS 105 can include any known GDS such as Sabre®, Travelport®, or Amadeus®. Each GDS provides a mechanism for receiving and responding to travel-related requests. Examples of travel service requests include flight requests and hotel requests. The GDS 105 maintains available inventory in an inventory database 105A. The GDS 105 can use multiple types of databases or data stores as needed.

The system 110 can utilize a hotel database 110A that includes hotels and descriptive data for those hotels. Examples include location, amenities, hotel group, and so forth. This database 110A is distinguishable from the inventory database 105A inasmuch as the inventory database 105A includes hotel room availability information.

Users, such as travel agents, can use a client device, such as client device 115. The client device 115 can include a travel agent terminal, a Smartphone, a laptop, or any other end user client device. End users can include travel agents, corporate employees, and individual travelers, as well as other similar end users.

As used herein, the terms “module” or “system” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The travel preference management system (referred to hereinafter as “system 110”) is configured to provide ranked and mapped inventory in response to requests. The responses are tailored to one or more sets of preferences. As mentioned above, the one or more sets of preferences can comprise corporate preferences, travel agency preferences, global preferences, local preferences, and traveler preferences. To be sure, corporate preferences reference inventory, such as a hotel or hotel group that offers a corporate discount. The travel agency preferences reference inventory that offers a particular reimbursement rate available for the travel agency or its clientele. The global preferences relate to inventory that offers reimbursements or incentives based on negotiations between a global entity such as a travel agency conglomerate or GDS group. Local preferences are related to location specific hotel incentives offered by a local hotel to a local or regional corporation.

Individual traveler preferences could relate to incentives or reimbursements at the individual traveler level, but also refer to guidelines that comprise attributes that are applied to travel inventory to filter out non-preferred inventory. For example, the traveler may have a strong preference against a hotel chain based on a lack of free parking or WiFi access. Thus, even if a hotel matches one or more of the incentive based travel preferences of a corporation or travel agency, the hotel may nevertheless be removed from consideration based on the traveler's preferences.

In some embodiments, the system administrator can define multiple entries of preferred hotels, which define how the system 110 will rank and display hotel inventory to the travel agent. As defined in Table 1, each hotel will have a data set associated with it by the system 110.

TABLE 1

| | | |
|---|---|---|
| Provider | “Sabre” | The ID of the provider of the hotel. Different |
| | | providers will have different IDs for the same |
| | | hotel |
| Hotel | “0027167”, | List of hotel id's |
| Code | “0015170” | |
| Priority | 1 | The priority of this entry compared to other |
| | | entries |
| Color | #FF0080 | The color the preferred properties will be |
| | or RED | visually highlighted |
| Letter | “H” | A character (one or more) that will visually |
| | | identify the preferred property in a list |

The data set associated with the system 110 is a function of hotel inventory attributes, compared against one or more set of preferences such as corporate and travel agency preferences.

In some embodiments, an administrator can define multiple preferred hotels as in with a data set as illustrated in Table 2.

TABLE 2

| Field | Example | Description |
|---|---|---|
| Provider | “Sabre” | The ID of the provider of the hotel. Different |
| | | providers will have different IDs for the same |
| | | hotel |
| Hotel | “0027167”, | List of hotel id's |
| Code | “0015170” | |
| Priority | 1 | The priority of this entry compared to other |
| | | entries |
| Color | #FF0080 | The color the preferred properties will be |
| | or RED | visually highlighted |
| Letter | “H” | A character (one or more) that will visually |
| | | identify the preferred property in a list |

In some embodiments, the system 110 is configured to create client (e.g., traveler records). These traveler records identify the sets of preferences that should be applied per client. For example, each client of an agency can be identified so that the agent can select the client profile on which they are working. For each client there is a set of rules describing its preferred chains and/or hotels, and in some embodiments other preferences described herein, including individual traveler preferences.

As mentioned above, when a request from a traveler is received by an agent or the system 110 directly, one or more sets of preferences can be applied. When more than one set of preferences is utilized, the system 110 can be configured to apply the different preference sets using a logical hierarchy.

Examples of preference sets that are organized according to a logical hierarchy can include traveler preferences first, travel agency preference second, and corporate preferences third. In another example, corporate preferences are first, travel agency preferences are second, and traveler preferences are third. Other permutations of preference sets are likewise contemplated and can include additional or fewer preferences than those outlined in these examples.

In yet another embodiment, the system 110 can be configured to further partition a permutation of preferences by whether specific hotels are preferred above hotel chains. One example may comprise: traveler preferences first, travel agency hotels second, corporate client hotels third, travel agency hotel chains fourth, and corporate client hotel chains fifth.

The system 110 can also be configured to apply preferences for a corporate client based upon its corporate structure. For example, a corporate client's North American operations may have different preference logic than their European operations.

In some instances, travel agencies can honor the clients' preference rules first and only secondarily utilize rules that benefit the agency according to their preferences. In another embodiment, an agency may decide to preference it's own rates ahead of the corporate clients' rates.

The system 110 will combine all the agency and client preferences into a single and intuitive display that can be visually overlaid on a map display or added to a list display and sorted accordingly, floating the highest preferred properties to the top.

As previously explained, there can be many preference sets that are applied to each inventor item that identifies the priority level of a specific inventory item for an agency or a client.

In some embodiments, the system 110 displays a highest preference level for an inventory item and ignores all the other preference rules that also apply to that inventory item. However, the system 110 can allow other permutations and combinations of additional preference alternatives.

In one example use case, an inventory item includes, the Sheraton Downtown Toronto as a possible hotel for a customer. Knowing the customer, the system 110 applies the following rules: (i) the Sheraton Chain is a Level 2 preferred hotel; (ii) the Starwood loyalty group is Level 3 preferred; and (iii) a specific location is close to client's corporate location and has a negotiated rate at Level 1. The overall preference level for the specified hotel will be set to Level 1.

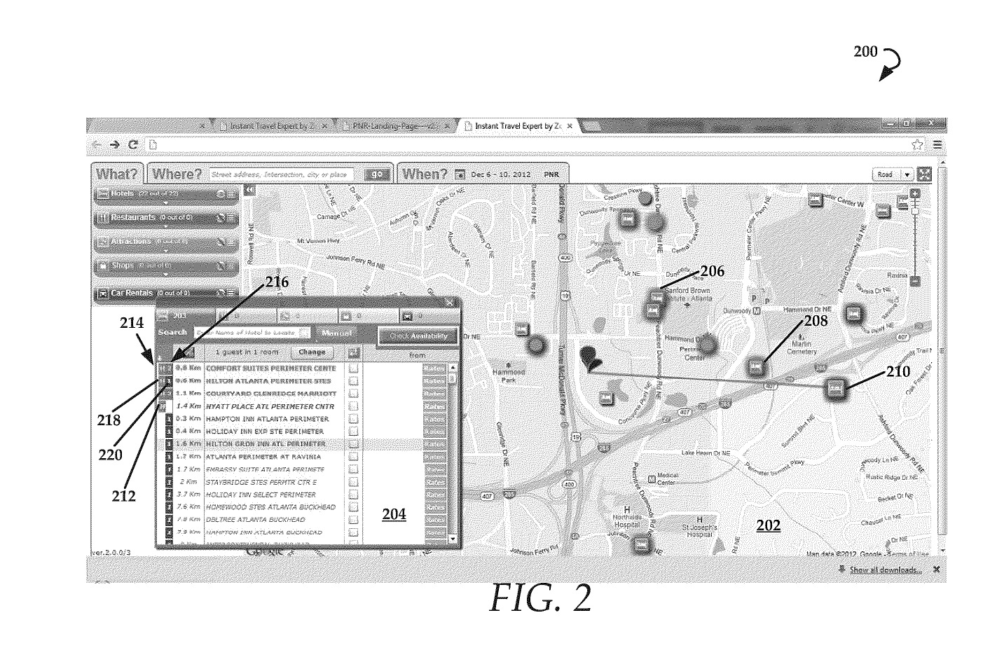

Referring now to FIG. 2, in one embodiment, the system 110 will facilitate the booking of hotels that are both clients' preferred and also agency preferred. This way the agency fulfills the obligation to the customer client and also collects incentives from the specific supplier that benefits the travel agency. To allow a clear indication of those properties that are both agency and client preferred, the system 110 displays two preferred fields for each property in the list view. A first column is client preferred level and the second column is the agency-preferred level.

When sorted by preferences, the corporate client preferred hotel options will be brought to the top followed by the agency preferred hotel options, but the properties that are preferred for both agency and client will be clearly visible or (based on configuration) will be pushed to the very top of the list by the system 110.

FIG. 2 is a screenshot of a graphical user interface 200 that is used to display hotel inventory items. The interface 200 generally comprises a map portion 202 and a list portion 204. The map portion 202 comprises all available hotels falling within the area defined in the map. Hotels that match a corporate preference can be identified by creating a magenta colored halo, such as shown with respect to hotel 206. Hotels matching both a corporate preference and a travel agency preference are denoted with a halo of a different color. For example, hotel 208 comprises a red halo. Hotels only corresponding to travel agency preferences only are displayed with yet a third colored halo, such as hotel 210 having a blue halo.

In yet other instances, the color of the halo used to visually distinguish a hotel on the map can be based on preference level or hierarchy logic. For example, hotel 208 corresponds to both a corporate preference and a travel agency preference, but the travel agency preference to which the hotel corresponds is only a Level 2 preference. By example, a travel agency may receive a greater reimbursement from Level 1 hotels as opposed to Level 2 hotels. The system can create additional colors for hotels that match corporate preferences and Level 1 preferences of the travel agency.

To aid the travel agent in better distinguishing these preferences and hierarchical selections, the list portion 204 includes the hotels in the map portion 202. The hotels are displayed according to preferences and hierarchical logic.

To be sure, hotel 206 is ranked fourth, hotel 208 is ranked second, and hotel 210 is ranked seventh. In some embodiments, the traveler preferences can function into the ranking of the hotels such as if the traveler needs the hotel to be within walking distance of a location.

In some embodiments, a hotel matching a corporate preference, such as hotel 206 is indicated with an icon 212. Hotel preference icons can be arranged into a column 214 within the list. A hotel matching both a corporate preference and a hotel preference, such as hotel 208, is indicated using a set of icons 218 and 220, where icon 218 indicates the hotel preference and icon 220 indicates the travel agency preference.

Icons indicating correspondence with a travel agency preference can be arranged into another column 216.

To be sure, the icons can also convey preference information to the travel agent. By way of example, a Level 1 travel agency preferred hotel is indicated by use of a blue icon with a numeral “1”. A Level 2 travel agency preferred hotel is indicated by use of a red icon with a numeral “2”.

Hotels that correspond to both corporate and travel agency preferences can nevertheless be eliminated from consideration based on traveler preferences that specify that traveler is to stay in a hotel that is within a certain geographical area.

Some of the embodiments described above can employ icons, shading, highlighting, italicizing, or other methods for visually representing or distinguishing preferred hotels or other inventory from one another on a display interface.

In some embodiments, corporate or traveler preferences may specify that a particular hotel or hotel chain should be designated or provided with a lower priority than other hotels. For example, a corporation may specify that Hilton™ hotels are to be given a low priority in any hotel request. In another example, the traveler may have had poor experiences with a particular hotel. In these instances, the preferences may be utilized to demote hotels that would otherwise comply with other corporate or traveler preferences.

These hotels (e.g, hotels not corresponding to any preference) can be visually distinguished from preferred hotels by an active demotion process. In one example, a hotel can be demoted by dimming or fading the hotel within the display interface, relative to other preferred hotels. In another example, a demoted hotel can be made of lower priority by moving the hotel to a bottom of a ranked list of hotels, removing the hotel from the list entirely, or making the hotel un-selectable on the list (e.g., the travel agent cannot select the hotel for booking).

In keeping with the example above, Hilton™ hotels, which would otherwise be returned in response to a preference query would be removed from the search results, placed towards the bottom of the ranked list, or made otherwise unavailable to the travel agent.

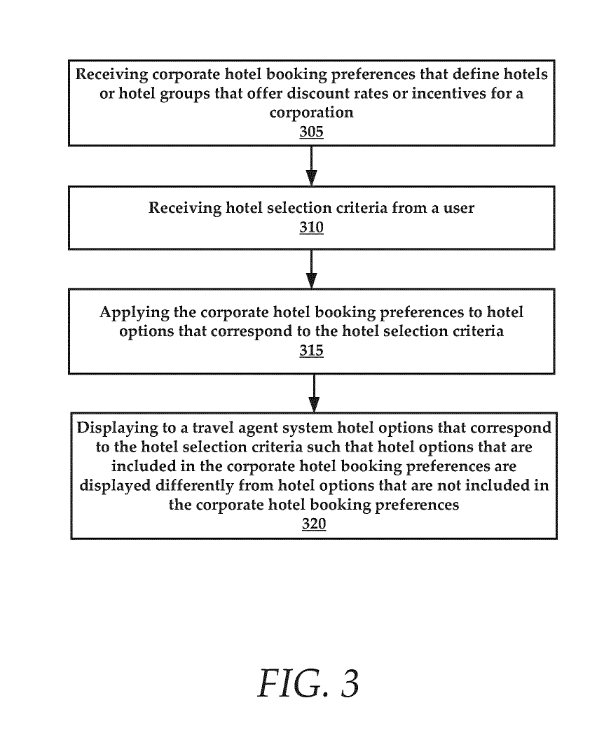

Referring now to FIG. 3, an example method for optimizing travel options selections through the use of preferences is illustrated. This method can be executed by the travel preference management system, for example. In another embodiment, the method can be executed, for example, at a web services platform of a GDS system.

In one embodiment, the method includes receiving 305 corporate hotel booking preferences that define hotels or hotel groups that offer discount rates or incentives for a corporation. To be sure, additional preferences can be utilized such as travel agency, global agency, local hotel, and/or traveler preferences.

The method also includes receiving 310 hotel selection criteria from a user. This step can include receiving a GDS formatted request for a traveler. To be sure, each GDS system has its own query commands and the travel agent constructs requests using these commands.

The method also comprises applying 315 the corporate hotel booking preferences to hotel options that correspond to the hotel selection criteria. The travel preference management system can process query results received from the GDS in response to the request. The travel preference management system will then apply the preferences to only the hotel options requested by the user, usually in accordance with a travel destination provided by the user. Thus, in some embodiments, steps 305-310 can be eliminated such that the travel preference management system is configured to apply preferences to only hotels returned from a query that may include other criteria such as location, dates, times, and other constraints.

In some embodiments, the method includes displaying 320 to a travel agent system hotel options that correspond to the hotel selection criteria such that hotel options that are included in the corporate hotel booking preferences are displayed differently from hotel options that are not included in the corporate hotel booking preferences. FIG. 2 provides various examples of how preferred options are displayed relative to options that do not correspond to any preferences.

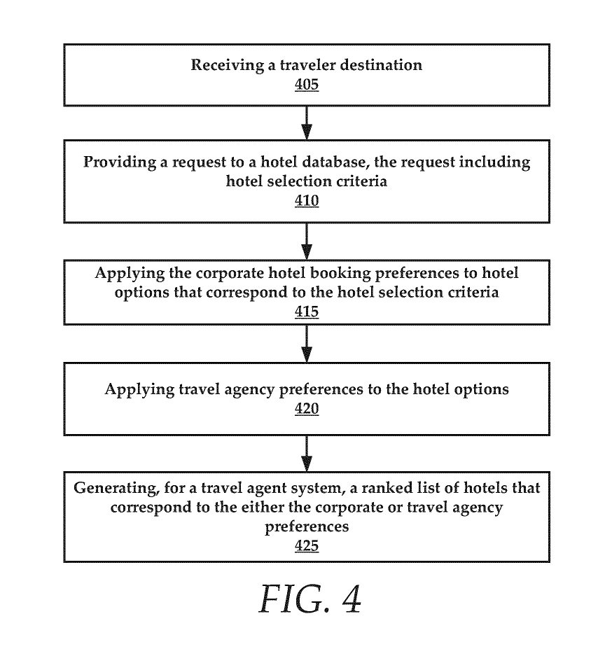

Referring now to FIG. 4, another method for optimizing travel options selections through the use of preferences is illustrated. The method includes receiving 405 a traveler destination and providing 410 a request to a hotel database that includes hotel selection criteria, which could include the destination. Next, the method includes applying 415 the corporate hotel booking preferences to hotel options that correspond to the hotel selection criteria.

The method also comprises applying 420 travel agency preferences to the hotel options. The travel agency preferences comprise hotels or groups of hotels that offer reimbursements to the travel agency.

The method also includes generating 425, for a travel agent system, a ranked list of hotel options. To be sure, hotel options included in the corporate hotel booking preferences and the travel agency preferences are placed near a top of the list.

In some embodiments, the hotel booking preferences include corporate, travel agency, and traveler preferences. The preferences can involve discounts or incentives offered by certain hotels or hotel groups. As mentioned above, the traveler preferences may or may not include a discount or incentive, but can include constraints that further restrict the hotel options chosen.

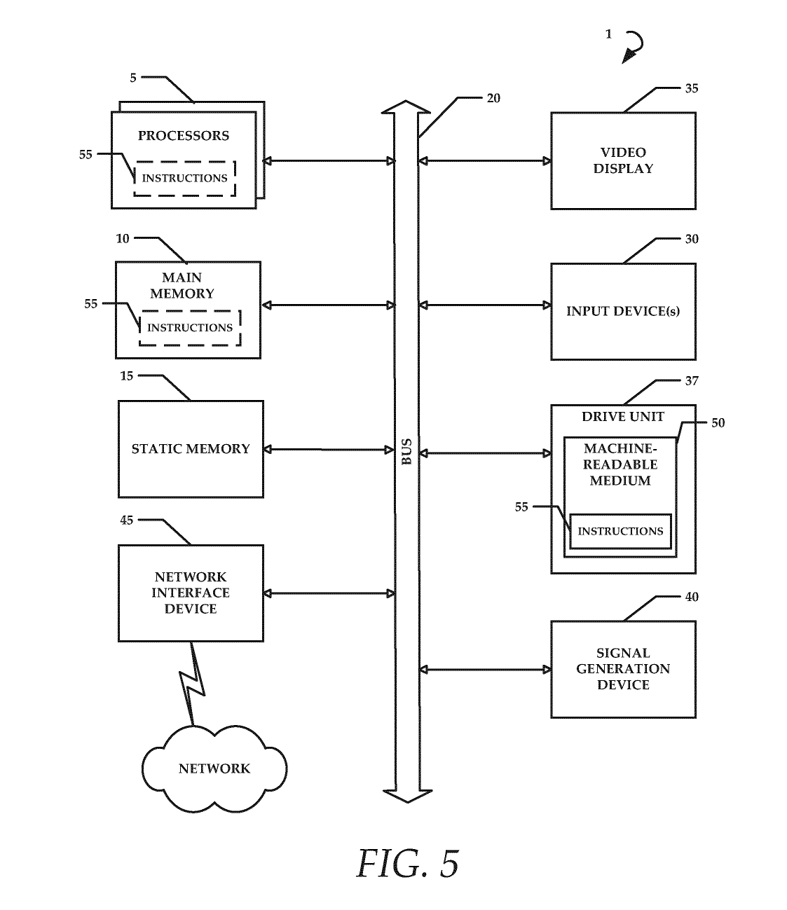

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving corporate hotel booking preferences that define hotels or hotel groups that offer discount rates for a corporation;
receiving hotel selection criteria from a user;
applying the corporate hotel booking preferences to hotels that correspond to the hotel selection criteria; and
displaying to a travel agent system hotels that correspond to the hotel selection criteria such that hotels that are included in the corporate hotel booking preferences are displayed differently from hotels that are not included in the corporate hotel booking preferences.

2. The method according to claim 1, wherein displaying comprises placing an icon next to each hotel that are included in the corporate hotel booking preferences.

3. The method according to claim 1, wherein a hotel that matches a hotel exclusion preference is not displayed to the travel agent system.

4. The method according to claim 1, wherein the hotels that are selected include hotels that are located geographically within a geographical boundary of a map interface on the travel agent system.

5. The method according to claim 1, wherein hotels that are outside the geographical boundary are displayed in a list and have a minimized visual appearance.

6. The method according to claim 1, further comprising applying travel agency preferences, wherein displaying further comprises visually distinguishing hotels that correspond to both the travel agency preferences and the corporate hotel booking preferences, wherein the travel agency preferences comprise hotels or groups of hotels that offer reimbursements to the travel agency.

7. The method according to claim 1, further comprising applying global preferences, wherein displaying further comprises visually distinguishing hotels that correspond to the global preferences, the travel agency preferences, and the corporate hotel booking preferences, wherein the global preferences comprise hotels or groups of hotels that offer reimbursements to the travel agency based on an agreement with a global travel entity.

8. A method, comprising:
receiving hotel selection criteria relating to a traveler;
applying the corporate hotel booking preferences to hotels that correspond to the hotel selection criteria, the corporate hotel booking preferences defining hotels or hotel groups that offer discount rates for a corporation;
applying travel agency preferences to the hotels, the travel agency preferences comprising hotels or groups of hotels that offer reimbursements to the travel agency; and
generating, for a travel agent system, a ranked list of hotels, wherein hotels that are included in the corporate hotel booking preferences and the travel agency preferences are placed near a top of the list.

9. The method according to claim 8, wherein each of the hotels that are included in the corporate hotel booking preferences and the travel agency preferences are indicated with a first type of visual representation.

10. The method according to claim 8, wherein each of the hotels that are included in the corporate hotel booking preferences only are indicated with a second type of visual representation.

11. The method according to claim 8, wherein each of the hotels that are not included in the corporate hotel booking preferences or the travel agency preferences are indicated with a third type of visual representation or no visual representation at all.

12. A system, comprising:
a processor; and
a memory for storing executable instructions, the processor executing the instructions to:
receive hotel booking preferences that define hotels or hotel groups that offer discount rates or incentives for at least one of a corporation, a travel agency, and a traveler;
receive hotel selection criteria from a user;
query a global distribution system using the hotel selection criteria received from a hotel database;
provide to a travel agent system, hotels that correspond to the hotel selection criteria and the hotel booking preferences.

13. The system according to claim 12, wherein the hotels are displayed on a map and a list within the same user interface.

14. The system according to claim 13, wherein the hotels are ranked in the list according to a highest preference level.

15. The system according to claim 13, wherein hotels that correspond to at least one corporate preference is displayed with a first icon or visual augmentation.

16. The system according to claim 15, wherein hotels that correspond to at least one corporate preference and at least one travel agency preference are displayed with a second icon or visual augmentation.

17. The system according to claim 16, wherein hotels that correspond to at least one corporate preference, at least one travel agency preference, and at least one traveler preference are displayed with a third icon or visual augmentation.

18. The system according to claim 12, wherein the hotel booking preferences further comprise corporate, travel agency, or traveler preferences regarding individual versus chain hotels.

19. The system according to claim 12, wherein the hotel booking preferences further comprise a combination of corporate, travel agency, and traveler preferences, the system applying each of the corporate, travel agency, and traveler preferences according to a logical hierarchy assigned thereto.

20. A method for integrating a map-based shopping and booking system with a global distribution system or other system, the method comprising:
accepting agency-preferred information;
storing the agency-preferred information;
allowing edits to be made to the agency-preferred information;
for each agency, client and traveler:
accepting preference information;
storing preference information; and
allowing edits to be made to the preference information;
combining and mixing agency-preferred information, client-preferred information and traveler-preference information;
displaying the agency-preferred information, client-preferred information, and traveler-preferred information simultaneously, allowing for comparisons between the agency-preferred information, client-preferred information, and traveler-preferred information to be made, with the display in the form of a map overlay and/or a list display; and
allowing for the booking of the selected option from at least one of the agency-preferred information, client-preferred information, and traveler-preferred information to the global distribution system or other system.
